(19) United States
(12) Patent Application Publication
(10) Pub. No.: US 2026/0277374 A1
(43) Pub. Date: Sep. 17, 2026

(54) INTERACTION CONTROL METHOD, DEVICE, ELECTRONIC APPARATUS AND MEDIUM

(71) Applicant: GOERTEK INC., Weifang, Shandong (CN)

(72) Inventors: Baocheng LI, Weifang, Shandong (CN); Mingming YANG, Weifang, Shandong (CN); Xudong QIU, Weifang, Shandong (CN); Qinghe YANG, Weifang, Shandong (CN); Yongfu CHEN, Weifang, Shandong (CN); Jiaming LI, Weifang, Shandong (CN); Yufeng LI, Weifang, Shandong (CN); Gaojian SHI, Weifang, Shandong (CN); Tongquan ZHANG, Weifang, Shandong (CN); Yueqing CHEN, Weifang, Shandong (CN); Lingfei XU, Weifang, Shandong (CN); Guoxin LI, Weifang, Shandong (CN)

(21) Appl. No.: 19/163,078

(22) PCT Filed: Jun. 18, 2024
(86) PCT No.: PCT/CN2024/099736

§ 371 Date: Sep. 8, 2025

(30) Foreign Application Priority Data
Aug. 16, 2023 (CN) 202311032642.5

(51) Int. Cl. G06F 3/0481; G06F 3/01; G06F 3/0482; G06F 3/0488

(52) U.S. Cl. CPC G06F 3/0481; G06F 3/012; G06F 3/0482; G06F 3/0488

(57) ABSTRACT

The present disclosure discloses an interaction control method, device, electronic apparatus and medium, the method comprises: receiving a touch operation of a user; if there is a collision point between a virtual identifier and a first application in an application list, creating a first virtual screen and a first window in response to the touch operation, running the first application on the first virtual screen, and rendering screen data of the first virtual screen to the first window; acquiring degrees-of-freedom information of a head-mounted display apparatus; and adjusting the first window according to the degrees-of-freedom information, encoding the screen data in the adjusted first window, and sending the encoded screen data to the head-mounted display apparatus for decoding and displaying.

The present application claims a priority to a Chinese patent application No. 202311032642.5, entitled “INTERACTION CONTROL METHOD, DEVICE, ELECTRONIC APPARATUS AND MEDIUM”, filed to the China Patent Office on Aug. 16, 2023, the entire contents of which are combined in the present application by reference.

### TECHNICAL FIELD

The present disclosure relates to a technical field of wearable apparatus, and more particularly, to an interaction control method, an interaction control device, an electronic apparatus and a computer-readable storage medium.

### DESCRIPTION OF RELATED ART

Split type has become an important trend in the development of AR (Augmented Reality). To reduce the power consumption of AR glasses, currently, the AR glasses are connected to a mobile apparatus, and content on the mobile apparatus is transmitted to the AR glasses for displaying. However, in the related art, there is a problem of how to transmit different content on the mobile apparatus to the AR glasses for displaying.

### SUMMARY

The purpose of embodiments of the present disclosure is to provide an interaction control method, device, electronic apparatus, and a medium.

According to a first aspect of the embodiments of the present disclosure, an interaction control method is provided, the interaction control method comprises:
receiving a touch operation of a user;
if there is a collision point between a virtual identifier and a first application in an application list, creating a first virtual screen and a first window in response to the touch operation, running the first application on the first virtual screen, and rendering screen data of the first virtual screen to the first window;
acquiring degrees-of-freedom information of a head-mounted display apparatus; and
adjusting the first window according to the degrees-of-freedom information, encoding the screen data in the adjusted first window, and sending the encoded screen data to the head-mounted display apparatus for decoding and displaying.

Optionally, after the adjusting the first window according to the degrees-of-freedom information, encoding the screen data in the adjusted first window, and sending the encoded screen data to the head-mounted display apparatus for decoding and displaying, the method further comprises:
if a touch event is received, acquiring position information of a collision point between the virtual identifier and the first window;
determining relative position information of the collision point in the first virtual screen according to the position information of the collision point between the virtual identifier and the first window; and
distributing the touch event to the first virtual screen for responding, according to the relative position information.

Optionally, the adjusting the first window according to the degrees-of-freedom information, encoding the screen data in the adjusted first window, and sending the encoded screen data to the head-mounted display apparatus for decoding and displaying comprises:
adjusting the first window according to the degrees-of-freedom information, compressing an edge region of the screen data in the adjusted first window and sending the compressed edge region to the head-mounted display apparatus for decoding and displaying.

Optionally, the adjusting the first window according to the degrees-of-freedom information, encoding the screen data in the adjusted first window, and sending the encoded screen data to the head-mounted display apparatus for decoding and displaying comprises:
adjusting the first window and a second window according to the degrees-of-freedom information; and
combining and encoding the screen data in the adjusted first window and screen data in the adjusted second window, and sending the combined and encoded screen data to the head-mounted display apparatus for decoding and displaying,
wherein the second virtual screen runs a second application, and the second window renders screen data of the second virtual screen.

Optionally, the method further comprises:
acquiring posture information of a terminal apparatus; and
controlling the virtual identifier to rotate according to the posture information, so that there is a collision point between the virtual identifier and a target application in the application list or between the virtual identifier and the first window,
wherein the target application is the first application or the second application.

According to a second aspect of the embodiments of the present disclosure, an interaction control device is provided, the interaction control device comprises:
a receiving module configured to receive a touch operation of a user;
a creating module configured to, if there is a collision point between a virtual identifier and a first application in an application list, create a first virtual screen and a first window in response to the touch operation, run the first application on the first virtual screen, and render screen data of the first virtual screen to the first window;
an acquiring module configured to acquire freedom information of a head-mounted display apparatus; and
a sending module configured to adjust the first window according to the degrees-of-freedom information, code the screen data in the adjusted first window, and send the encoded screen data to the head-mounted display apparatus for decoding and displaying.

Optionally, the interaction control device further comprises a determining module,
wherein the acquiring module is further configured to acquire position information of a collision point between the virtual identifier and the first window if a touch event is received;
wherein the determining module is configured to determine relative position information of the collision point in the first virtual screen according to the position information of the collision point; and
wherein the sending module is configured to distribute the touch event to the first virtual screen for responding, according to the relative position information.

Optionally, the sending module is particularly configured to:
adjust the first window according to the degrees-of-freedom information, compress an edge region of the screen data in the adjusted first window, and send the compressed edge region to the head-mounted display apparatus for decoding and displaying.

Optionally, the sending module is particularly configured to:
adjust the first window and a second window according to the degrees-of-freedom information; and
combine and code the screen data in the adjusted first window and screen data in the adjusted second window, and send the combined and encoded screen data to the head-mounted display apparatus for decoding and displaying,
wherein a second virtual screen runs a second application, and the second window renders screen data of the second virtual screen.

Optionally, the interaction control device further comprises a control module.
the acquiring module is further configured to acquire posture information of a terminal apparatus;
wherein the control module is configured to control the virtual identifier to rotate according to the posture information, so that there is a collision point between the virtual identifier and a target application in the application list or between the virtual identifier and the first window; and
wherein the target application is the first application or the second application.

According to a third aspect of the embodiments of the present disclosure, an electronic apparatus is provided, the electronic apparatus comprises:
a memory configured to store executable computer instructions; and
a processor configured to implement the interaction control method according to the above-described first aspect, according to a control of the executable computer instructions.

According to a fourth aspect of the embodiments of the present disclosure, a computer-readable storage medium having computer instructions stored thereon is provided, wherein the interaction control method according to the first aspect is performed when the computer instructions are executed by a processor.

A technical effect of the embodiment of the present disclosure is that, when a terminal apparatus receives a touch operation of a user, if there is a collision point between a virtual identifier and a first application in an application list, creating a first virtual screen and a first window in response to the touch operation, running the first application on the first virtual screen, and rendering screen data of the first virtual screen to the first window, and acquiring degrees-of-freedom information of a head-mounted display apparatus, and adjusting the first window according to the degrees-of-freedom information, and encoding the screen data in the adjusted first window and sending the encoded screen data to the head-mounted display apparatus for decoding and displaying. That is, the user may transmit different application scenarios rendered by the terminal apparatus to the head-mounted display apparatus for displaying, according to his/her own needs.

Other features and advantages of the description will become apparent from the following detailed description of exemplary embodiments of the description with reference to the drawings.

### BRIEF DESCRIPTION OF DRAWINGS

To more clearly illustrate the technical solutions in the embodiments of the present disclosure or the prior art, a brief introduction will be made to the drawings required to be used in the description of the embodiments or the prior art below. It is obvious that the drawings described below are only some embodiments of the present disclosure. For those skilled in the art, without making creative efforts, other drawings can also be obtained according to the structures shown in these drawings.

FIG. 1 is a schematic diagram of a hardware configuration of an interaction control system according to an embodiment of the present disclosure;

FIG. 2 is a schematic flowchart of an interaction control method according to an embodiment of the present disclosure;

FIG. 3 is a schematic diagram of an interface display of a terminal apparatus according to an embodiment of the present disclosure;

FIG. 4 is a schematic diagram of an interface display of a terminal apparatus according to another embodiment of the present disclosure; and

FIG. 5 is a principle block diagram of an interaction control device according to an embodiment of the present disclosure.

Implementations, functional features, and advantages of the present disclosure will be further described with reference to the drawings and embodiments.

### DETAILED DESCRIPTIONS

The following describes the technical solutions in the embodiments of the present disclosure clearly and completely with reference to the drawings in the embodiments of the present invention. Obviously, the described embodiments are only a part of the embodiments of the present disclosure, but not all the embodiments. All other embodiments obtained by those skilled in the art according to the embodiments of the present disclosure without making creative efforts fall within the protection scope of the present disclosure.

It should be noted that, if there is related to a directional indication (such as up, down, left, right, front, back . . . ) in the embodiments of the present disclosure, the directional indication is only used to explain the relative positional relationship, motion condition, etc. between the components at a specific posture (as shown in the drawings), and if the specific posture changes, the directional indication also changes accordingly.

In addition, if there are descriptions related to “first”, “second” etc. in the embodiments of the present disclosure, the descriptions of “first”, “second” etc. are only used for descriptive purposes, and cannot be understood as indicating or implying their relative importance or implicitly indicating the number of indicated technical features. Thus, features defined with “first” and “second” may explicitly or implicitly comprise at least one of the features. In addition, the meaning of “and/or” appearing throughout the description comprises three parallel solutions, taking “A and/or B” as an example, comprising a solution A, or a solution B, or solutions that both solution A and solution B are satisfied. In addition, the technical solutions of the various embodiments may be combined with each other, but must be based on that it can be implemented by those skilled in the art, and when the combination of the technical solutions is contradictory or cannot be implemented, it should be considered that the combination of the technical solutions does not exist, and is not within the protection scope claimed to be protected by the present disclosure.

### Hardware Configuration

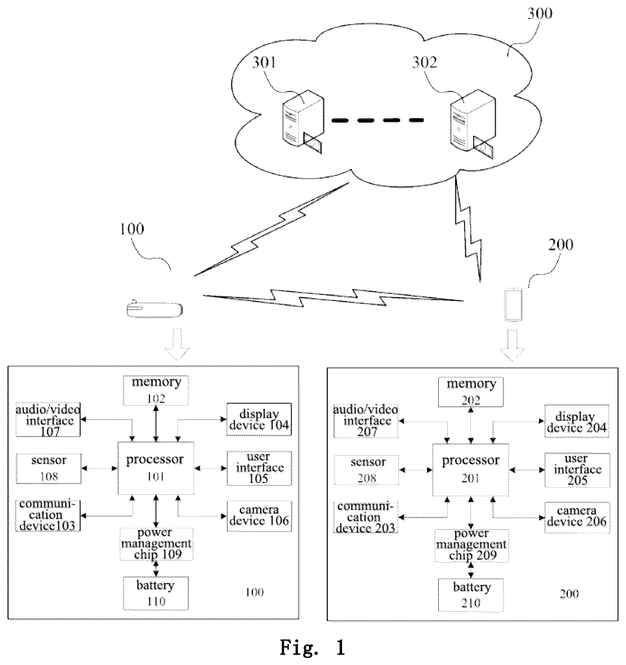

FIG. 1 is a schematic diagram of a hardware configuration of an interaction control system that can be used to implement an interaction control method according to an embodiment. FIG. 1 shows a head-mounted display apparatus 100, a terminal apparatus 200 and a network 300. The head-mounted display apparatus 100 may be connected to the network 300, and may also be connected with the terminal apparatus 200 by communication manner such as Bluetooth. In an embodiment, the head-mounted display apparatus 100 is connected with the terminal apparatus 200 respectively only by communication manner such as Bluetooth. A plurality of servers 301 and 302 may be disposed in the network 300. The network 300 may be a wireless communication network or a wired communication network. The network 300 may be a local area network or a wide area network. The network 300 may perform short-range communication or long-range communication.

In an embodiment, as shown in FIG. 1, the head-mounted display apparatus 100 may comprise a processor 101 and a memory 102. The head-mounted display apparatus 100 further comprises a communication device 103, a display device 104, a user interface 105, a camera device 106, an audio/video interface 107, a sensor 108, etc. In addition, the head-mounted display apparatus 100 may further comprise a power management chip 109 and a battery 110, etc.

Among them, the processor 101 may be various processors. The memory 102 may store underlying software, system software, application software, data, etc. required for the operation of the head-mounted display apparatus 100. The memory 102 may comprise various types of memory, such as ROM, RAM, Flash, etc. For example, the communication device 103 may comprise a WiFi communication device, a Bluetooth communication device, 3G, 4G and 5G communication devices, etc. Through the communication device 103, the head-mounted display apparatus 100 may be arranged in the network. The display device 104 may be a liquid crystal display, an OLED display, etc. In one example, the display device 104 may be a touch screen. The user may perform an input operation through the display device 104. In addition, the user may also perform a fingerprint recognition and the like through the touch screen. The user interface 105 may comprise a USB interface, a lightning interface, a keyboard, etc. The camera device 106 may be a single camera or multiple cameras. For example, the audio/video interface 107 may comprise a loudspeaker interface, a microphone interface, a video transmission interface such as HDMI, etc. For example, the sensor 108 may comprise a gyroscope, an accelerometer, a temperature sensor, a humidity sensor, a pressure sensor, etc. For example, posture information and the like of the head-mounted display apparatus may be determined by the sensor. The power management chip 109 may be configured to manage the power of an power source input to the head-mounted display apparatus 100, and may also manage the battery 110 to ensure a greater utilization efficiency. For example, the battery 110 is a lithium-ion battery, etc.

The head-mounted display apparatus 100 may be AR (Augmented Reality) glasses, MR (Mixed Reality) glasses, etc., and the AR glasses may be split type AR glasses, and the MR glasses may be split type MR glasses, which is not limited in the embodiments of the present disclosure. The various components shown in FIG. 1 are merely illustrative. The head-mounted display apparatus 100 may comprise one or more of the components shown in FIG. 1, but not necessarily comprise all of the components shown in FIG. 1. The head-mounted display apparatus 100 shown in FIG. 1 is merely illustrative and is not intended to limit the embodiments, their applications or uses herein.

In an embodiment, as shown in FIG. 1, the terminal apparatus 200 may comprise a processor 201 and a memory 202. The terminal apparatus 200 further comprises a communication device 203, a display device 204, a user interface 205, a photograph device 206, an audio/video interface 207 and a sensor 208, etc. In addition, the terminal apparatus 200 may further comprise a power management chip 209 and a battery 210, etc.

The terminal apparatus 200 may be a mobile phone, a portable computer, a tablet computer, a palmtop computer, a wearable apparatus, etc., which is not limited in the embodiment of the present disclosure. For example, the terminal apparatus may be an Android apparatus. For instance, the terminal device may be an Android apparatus having the display device 204, or the terminal device may be an Android apparatus not having the display device 204. That is, the various components shown in FIG. 1 are merely illustrative. The terminal apparatus 200 may comprise one or more of the components shown in FIG. 1, but not necessarily all of the components shown in FIG. 1. The terminal apparatus 200 shown in FIG. 1 is merely illustrative and is not intended to limit the embodiments herein, their applications or uses.

In this embodiment, the memory 202 of the terminal apparatus 200 is configured to store program instructions, the program instructions are configured to control the processor 201 to perform an operation so as to implement the interaction control method, and those skilled in the art may design the instructions according to the solution disclosed in the present disclosure. It is well known in the art about how to control the processor to operate by the instructions, which will not be described in detail herein.

It should be understood that, although FIG. 1 only shows one head-mounted display apparatus 100 and one terminal apparatus 200, it is not mean to limit the numbers thereof, and the interaction control system may comprise a plurality of head-mounted display apparatuses 100 and a plurality of terminal apparatuses 200.

In the above description, those skilled in the art may design the instructions according to the solutions provided by the present disclosure. It is well known in the art about how to control the processor to operate by the instructions, which will not be described in detail herein.

### Method Embodiment

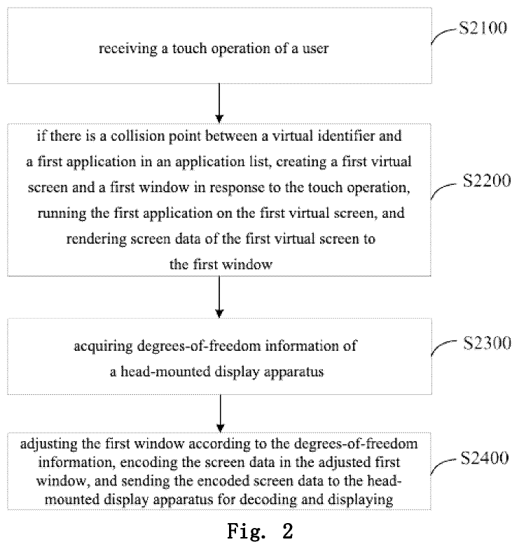

FIG. 2 shows an interaction control method of an embodiment of the present disclosure, and the interaction control method may be implemented by the terminal apparatus as shown in FIG. 1, and for example, the terminal apparatus may be an Android device not having the display device 204. As shown in FIG. 2, the interaction control method in this embodiment may comprise following steps S2100 to S2400.

Step S2100: receiving a touch operation of a user.

Among them, the touch operation may be a touch operation of starting the first application performed by the user on a touchpad of the terminal apparatus.

In this embodiment, the desktop launcher of the terminal apparatus is referred to as Launcher, and the Launcher (the desktop launcher) is automatically started when the terminal apparatus is powered on. A physical screen of the terminal apparatus has a control application running thereon, and usually, the control application runs at a front end of the terminal apparatus, to ensure the normal use of the touchpad of the terminal apparatus.

After performing the receiving a touch operation of a user in the S2100, the process proceeds to:

Step S2200: if there is a collision point between a virtual identifier and a first application in an application list, creating a first virtual screen and a first window in response to the touch operation, running the first application on the first virtual screen, and rendering screen data of the first virtual screen to the first window.

Among them, the virtual identifier may represent a current posture of the terminal apparatus, and the user may control the terminal apparatus according to the virtual identifier. For example, the virtual identifier may be a virtual ray. The virtual ray may be a straight line, or the virtual ray may be a curve, which is not limited in this embodiment.

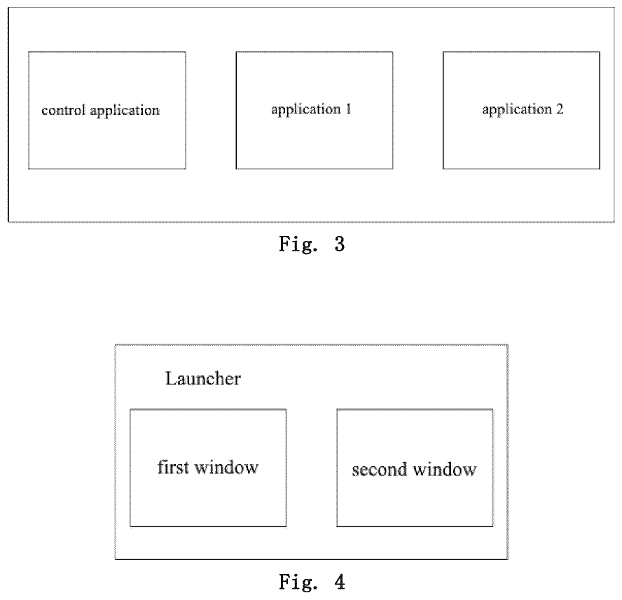

In an embodiment, when the terminal apparatus is connected with the head-mounted display apparatus in a manner of streaming connection, the terminal apparatus renders and displays the application list by Launcher. Referring to FIG. 3, an icon of a control application, an icon of an application 1, and an icon of an application 2 are displayed in the application list. At the same time, the terminal apparatus codes the rendered application list and sends the encoded application list to the head-mounted display apparatus for decoding and displaying, based on the streaming connection with the head-mounted display apparatus.

Among them, the streaming connection established between the terminal apparatus and the head-mounted display apparatus may be a wired streaming connection or a wireless streaming connection, which is not limited in this embodiment.

Specifically, when the terminal apparatus detects that there is a collision point between the virtual identifier and the icon of the first application in the application list displayed by the head-mounted display apparatus, the terminal apparatus may create the first virtual screen and the first window in the Launcher in response to the first touch operation, run the first application on the first virtual screen, obtain the left screen data and the right screen data according to the screen data of the first virtual screen and render the obtained left screen data and the right screen data to the first window. For example, referring to FIG. 4, the first virtual screen runs the application 1, and the first window renders the screen data of the first virtual screen.

Step S2300, acquiring degrees-of-freedom information of the head-mounted display apparatus.

Among them, the degrees-of-freedom information of the head-mounted display apparatus refers to six degrees of freedom information (hereinafter referred to as 6DoF information) of the head-mounted display apparatus, comprising a movement freedom and a rotation freedom.

In an embodiment, after the camera device of the head-mounted display apparatus acquires the first image, the head-mounted display apparatus can perform calculation by using a simultaneous localization and mapping (SLAM) algorithm according to the spatial structure information in the first image, to obtain a movement freedom (that is, three-dimensional coordinates) of the head-mounted display apparatus; the head-mounted display apparatus can obtain a rotation freedom (that is, a yaw angle, a pitch angle, and a roll angle) of the head-mounted display apparatus according to posture information (for example, quaternion information) of the head-mounted display apparatus acquired by an inertial measurement unit of the head-mounted display apparatus; and the head-mounted display apparatus can determine the 6DoF information of the head-mounted display apparatus by using the movement freedom and the rotation freedom.

Specifically, after the head-mounted display apparatus acquires the degrees-of-freedom information of the head-mounted display apparatus, the head-mounted display apparatus sends the degrees-of-freedom information of the head-mounted display apparatus to the terminal apparatus.

Step S2400, adjusting the first window according to the degrees-of-freedom information, encoding the screen data in the adjusted first window, and sending the encoded screen data to the head-mounted display apparatus for decoding and displaying.

Specifically, the terminal apparatus may adjust the first window according to the degrees-of-freedom information of the head-mounted display apparatus, and sends the screen data rendered by the first window to the head-mounted display apparatus for decoding and displaying, that is, the head-mounted display apparatus only serves as the display device of the terminal apparatus to display the screen data.

In an embodiment, the step S2400, i.e., the adjusting the first window according to the degrees-of-freedom information, encoding the screen data in the adjusted first window, and sending the encoded screen data to the head-mounted display apparatus for decoding and displaying, may further comprise: adjusting the first window according to the degrees-of-freedom information, and compressing an edge region of the screen data in the adjusted first window and sending the compressed edge region to the head-mounted display apparatus for decoding and displaying.

In this embodiment, if the data amount of the screen data of the adjusted first window is greater than the preset data amount, then since the head-mounted display apparatus has lens distortion itself, the terminal apparatus compresses the edge region of the screen data in the adjusted first window and sends the compressed edge region to the head-mounted display apparatus for decoding and displaying.

In an embodiment, the step S2400, i.e., the adjusting the first window according to the degrees-of-freedom information, encoding the screen data in the adjusted first window, and sending the encoded screen data to the head-mounted display apparatus for decoding and displaying, may further comprise: adjusting the first window and a second window according to the degrees-of-freedom information; and combining and encoding the screen data in the adjusted first window and screen data in the adjusted second window, and sending the combined and encoded screen data to the head-mounted display apparatus for decoding and displaying.

Among them, a second virtual screen runs a second application, and the second window renders screen data of the second virtual screen.

It should be noted that, the terminal apparatus may also receive a touch operation of the user, wherein the touch operation may be a touch operation of starting the second application performed by the user on the touchpad of the terminal apparatus. When the terminal apparatus detects that there is a collision point between the virtual identifier and the icon of the second application in the application list, the terminal apparatus may create the second virtual screen and the second window in response to the touch operation, run the second application on the second virtual screen, and obtain the left screen data and the right screen data according to the screen data of the second virtual screen and render the obtained left screen data and the right screen data to the second window. In other words, the control application in the terminal apparatus runs on the physical screen, and each of other applications in the terminal apparatus runs on the corresponding virtual screen. This embodiment does not specifically limit the number of applications.

For example, referring to FIG. 4, the second virtual screen runs the application 2, and the second window renders the screen data of the second virtual screen.

In this embodiment, the terminal apparatus adjusts the first window and the second window respectively according to the degrees-of-freedom information of the head-mounted display apparatus, and combines and codes the screen data rendered by the adjusted first window and the screen data rendered by the adjusted second window and sends them to the head-mounted display apparatus for decoding and displaying.

According to this embodiment, when the terminal apparatus receives the touch operation of the user, if there is a collision point between a virtual identifier and a first application in the application list, then the terminal apparatus may create a first virtual screen and a first window in response to the touch operation, run the first application on the first virtual screen, and render screen data of the first virtual screen to the first window, acquire freedom information of the head-mounted display apparatus, and adjust the first window according to the degrees-of-freedom information and then code the screen data in the adjusted first window and send the encoded screen data to the head-mounted display apparatus for decoding and displaying. That is, the user may transmit different application scenarios rendered by the terminal apparatus to the head-mounted display apparatus for displaying, according to his/her own needs.

In an embodiment, after performing the above step S2300 of adjusting the first window according to the degrees-of-freedom information, encoding the screen data in the adjusted first window, and sending the encoded screen data to the head-mounted display apparatus for decoding and displaying, the interaction control method of the embodiment of the present disclosure further comprises the following steps S3100 to S3300:
Step S3100: acquiring position information of a collision point between the virtual identifier and the first window when a touch event is received.

Among them, the touch event may be a pressing event, a sliding event, etc.

In this embodiment, when the terminal apparatus receives the touch event performed by the user on the touchpad, if the terminal apparatus detects that there is a collision point between the virtual identifier and the first window displayed by the head-mounted display apparatus, acquiring the position information of the collision point between the virtual identifier and the first window.
Step S3200: determining relative position information of the collision point in the first virtual screen according to the position information of the collision point.
Step S3300: distributing the touch event to the first virtual screen for responding, according to the relative position information.

According to this embodiment, the terminal apparatus may distribute the touch event implemented by the user to the corresponding virtual screen for responding.

In an embodiment, the interaction control method of the embodiment of the present disclosure further comprises the following steps S4100 to S4200.
Step S4100: acquiring posture information of a terminal apparatus.

In this embodiment, the posture information (for example, quaternion information) of the terminal apparatus is acquired according to an inertial measurement unit of the terminal apparatus.
Step S4200: controlling the virtual identifier to rotate according to the posture information, so that there is a collision point between the virtual identifier and a target application in the application list or between the virtual identifier and the first window;

Among them, the target application is the first application or the second application.

In this embodiment, the terminal apparatus may acquire a rotational freedom (that is, a yaw angle, a pitch angle, and a roll angle) of the head-mounted display apparatus according to the posture information, and the rotational freedom may be serve as the 3DoF information of the terminal apparatus. Then, the terminal apparatus controls the virtual identifier to rotate according to the 3DoF information, so that there is a collision point between the virtual identifier and the icon of the first application in the application list or between the virtual identifier and the icon of the second application in the application list, or between the virtual identifier and the first window.

### Interaction Control Device Embodiment

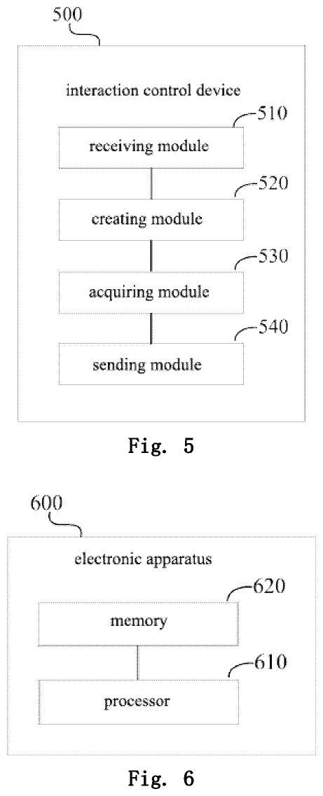

FIG. 5 is a principle schematic diagram of an interactive control device according to an embodiment of the present disclosure. Referring to FIG. 5, the interaction control device 500 comprises a receiving module 510, a creating module 520, an acquiring module 53, and a sending module 540.
The receiving module 510 is configured to receive a touch operation of a user;
The creating module 520 is configured to, if there is a collision point between a virtual identifier and a first application in an application list, create a first virtual screen and a first window in response to the touch operation, run the first application on the first virtual screen, and render screen data of the first virtual screen to the first window;
The acquiring module 530 is configured to acquire freedom information of a head-mounted display apparatus;
The sending module 540 is configured to adjust the first window according to the degrees-of-freedom information, code the screen data in the adjusted first window and send the encoded screen data to the head-mounted display apparatus for decoding and displaying.

In an embodiment, the interaction control device further comprises a determining module (not shown in the drawing).
The acquiring module 530 is further configured to acquire position information of a collision point between the virtual identifier and the first window when a touch event is received;
The determining module is configured to determine relative position information of the collision point in the first virtual screen according to the position information of the collision point; and
The sending module 540 is further configured to distribute the touch event to the first virtual screen for responding, according to the relative position information.

In an embodiment, the sending module 540 is specifically configured to adjust the first window according to the degrees-of-freedom information, and compress an edge region of the screen data in the adjusted first window, and send the compressed edge region to the head-mounted display apparatus for decoding and displaying.

In an embodiment, the sending module 540 is specifically configured to adjust the first window and a second window according to the degrees-of-freedom information, combine and code the screen data in the adjusted first window and screen data in the adjusted second window, and send the combined and encoded screen data to the head-mounted display apparatus for decoding and displaying, wherein the second virtual screen runs a second application, and the second window renders screen data of the second virtual screen.

In an embodiment, the interaction control device further comprises a control module (not shown in the drawing).
The acquiring module 530 is further configured to acquire posture information of a terminal apparatus;
The control module is configured to control the virtual identifier to rotate according to the posture information, so that there is a collision point between the virtual identifier and a target application in the application list or between the virtual identifier and the first window;

Among them, the target application is the first application or the second application.

According to this embodiment of the present disclosure, when the terminal apparatus receives the touch operation of the user, if there is a collision point between a virtual identifier and a first application in an application list, the terminal apparatus may create a first virtual screen and a first window in response to the touch operation, run the first application on the first virtual screen, and render the screen data of the first virtual screen to the first window, acquire the degrees-of-freedom information of the head-mounted display apparatus, and adjust the first window according to the degrees-of-freedom information, and then code the screen data in the adjusted first window and send the encoded screen data to the head-mounted display apparatus for decoding and displaying. That is, the user may transmit different application scenarios rendered by the terminal apparatus to the head-mounted display apparatus for displaying according to his/her own needs.

### Electronic Apparatus Embodiment

FIG. 6 is a schematic diagram of a hardware structure of an electronic apparatus according to an embodiment. As shown in FIG. 6, the electronic apparatus 600 comprises a processor 610 and a memory 620.

The memory 620 may be configured to store executable computer instructions.

The processor 610 may be configured to implement the interaction control method of the embodiment of the present disclosure according to a control of the executable computer instructions.

The electronic apparatus 600 may be the head-mounted display apparatus 100 shown in FIG. 1, or may be the terminal apparatus 200 shown in FIG. 1, or may be an apparatus having other hardware structure, which is not limited herein.

In another embodiment, the electronic apparatus 600 may comprise the above-described interaction control device 500.

In an embodiment, modules of the interaction control device 600 may be implemented by running the computer instructions stored in the memory 620 via the processor 610.

### Computer-Readable Storage Medium

An embodiment of the present disclosure further provides a computer-readable storage medium having computer instructions stored thereon, and the interaction control method provided by the embodiment of the present disclosure is performed when the computer instructions are executed by a processor.

The present disclosure may be a system, a method, and/or a computer program product. The computer program product may comprise a computer readable storage medium with computer readable program instructions for making a processor to implement aspects of the present disclosure loaded thereon.

The computer readable storage medium may be a tangible apparatus that can retain and store instructions used by an instruction execution apparatus. For example, the computer readable storage medium may be an electronic storage apparatus, a magnetic storage apparatus, an optical storage apparatus, an electromagnetic storage apparatus, a semiconductor storage apparatus, or any suitable combination thereof, but is not limited thereto. More specific examples (a non-exhaustive list) of the computer readable storage medium comprises: a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded apparatus such as punch-card or raised structures in a groove having instructions recorded thereon, and any suitable combination thereof. The computer readable storage medium used herein is not to be construed as being a transitory signal itself, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein may be respectively downloaded to the computing/processing apparatuses from the computer readable storage medium or to an external computer or an external storage apparatus via a network, for example, the Internet, a local area network, a wide area network and/or a wireless network. The network may comprise copper transmission cables, optical fibers transmission, wireless transmission, routers, firewalls, switches, gateway computers and/or edge servers. A network adapter card or network interface in each computing/processing apparatus receives computer readable program instructions from the network and forwards the computer readable program instructions for storing into the computer readable storage mediums within the respective computing/processing apparatus.

Computer readable program instructions for executing the operations of the present disclosure may be assembler instructions, instruction-set-architecture (ISA) instructions, machine instructions, machine related instructions, microcode, firmware instructions, state-setting data, or either source code or object code written in any combination of one or more programming languages, comprising an object oriented programming language such as Smalltalk, C++ etc., and conventional procedural programming languages such as the “C” programming language or similar programming languages. The computer readable program instructions may be executed entirely on the user's computer, executed partly on the user's computer, executed as a stand-alone software package, executed partly on the user's computer and partly on a remote computer or executed entirely on the remote computer or server. When related to the remote computer, the remote computer may be connected to the user's computer through any type of network, comprising a local area network (LAN) or a wide area network (WAN), or may be connected to an external computer (for example, through the Internet by using an Internet Service Provider). In some embodiments, using the state information of the computer-readable program instructions to customize electronic circuits, such as programmable logic circuits, field programmable gate arrays (FPGA), or programmable logic arrays (PLA), the electronic circuit may execute computer-readable program instructions, thereby implementing various aspects of the present disclosure.

Aspects of the present disclosure are described herein with reference to flowcharts and/or block diagrams of method, device (system), and computer program product according to embodiments of the present disclosure. It will be understood that each block of the flowcharts and/or block diagrams and combinations of blocks in the flowcharts and/or block diagrams may be implemented by computer readable program instructions.

These computer readable program instructions may be provided to a processor of a general-purpose computer, special purpose computer, or other programmable data processing device to produce a machine, such that device for implementing the functions/operations specified in one or more blocks in the flowcharts and/or block diagrams is created when the instructions are executed by the processor of the computer or other programmable data processing devices. These computer readable program instructions may also be stored in a computer readable storage medium, and these computer readable program instructions make the computer, the programmable data processing device, and/or other apparatuses to operate in a particular manner, such that the computer readable storage medium having instructions stored therein comprises an article of manufacture comprising instructions which implement aspects of the function/operation specified in one or more blocks in the flowcharts and/or block diagrams.

The computer readable program instructions may also be loaded onto a computer, other programmable data processing devices, or other apparatuses to make a series of operation steps to be performed on the computer, other programmable data processing devices or other apparatuses to produce a computer implemented process, such that the instructions which executed on the computer, other programmable data processing devices, or other apparatuses implement the functions/operations specified in one or more blocks of the flowcharts and/or block diagrams.

The flowcharts and block diagrams in the drawing illustrate possible implemented architecture, functionality, and operation of system, method, and computer program product according to various embodiments of the present disclosure. In this regard, each block in the flowcharts or the block diagrams may represent a portion of one module, segment or instruction, which comprises one or more executable instructions for implementing the specified logical functions. In some alternative implementations, the functions marked in the block may be executed in the order different from that marked in the drawing. For example, two blocks shown in succession may, in fact, be executed substantially concurrently, or may sometimes be executed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions. It is well known for those skilled in the art that implementation by hardware, implementation by software, and implementation by a combination of software and hardware are all equivalent. It should be noted that, in this specification, the terms “comprise”, “include”, or any other variant thereof are intended to cover non-exclusive inclusion, so that a process, method, article or system that comprises a series of elements comprises not only those elements, but also other elements that are not explicitly listed, or elements inherent to such a process, method, article, or system. An element defined by “comprises a . . . ” does not, without more constraints, preclude the existence of additional identical elements in the process, method, article, or system that comprises the element.

The sequence numbers of the embodiments of the present disclosure are merely for description, and do not represent the preference of the embodiments.

Through the description of the above embodiments, those skilled in the art may clearly understand that the methods in the above embodiments may be implemented by using software and a necessary general hardware platform, or may be implemented by using hardware. In many cases, the former is a better implementation method. According to such understanding, the technical solution of the present disclosure essentially or the part contributing to the prior art may be embodied in the form of a software product, and the computer software product is stored in a storage medium (such as a ROM/RAM, a magnetic disk, or an optical disk) as above, and comprises several instructions to enable a terminal apparatus (which may be a mobile phone, a computer, a server, a television, or a network device, etc.) to execute the method of each embodiment of the present disclosure.

The above descriptions are only preferred embodiments of the present disclosure, and are not intended to limit the patent scope of the present disclosure, and any equivalent structural transformation made by using the content of the specification and the drawings of the present disclosure or directly/indirectly applied to other related technical fields under the inventive concept of the present disclosure are comprised in the patent protection scope of the present disclosure.

1. An interaction control method, comprising:
receiving a touch operation of a user;
if there is a collision point between a virtual identifier and a first application in an application list, creating a first virtual screen and a first window in response to the touch operation, running the first application on the first virtual screen, and rendering screen data of the first virtual screen to the first window;
acquiring degrees-of-freedom information of a head-mounted display apparatus; and
adjusting the first window according to the degrees-of-freedom information, encoding the screen data in the adjusted first window, and sending the encoded screen data to the head-mounted display apparatus for decoding and displaying.

2. The interaction control method according to claim 1, wherein after the adjusting the first window according to the degrees-of-freedom information, encoding the screen data in the adjusted first window, and sending the encoded screen data to the head-mounted display apparatus for decoding and displaying, the method further comprises:
if a touch event is received, acquiring position information of a collision point between the virtual identifier and the first window;
determining relative position information of the collision point in the first virtual screen according to the position information of the collision point between the virtual identifier and the first window; and
distributing the touch event to the first virtual screen for responding, according to the relative position information.

3. The interaction control method according to claim 1, wherein the adjusting the first window according to the degrees-of-freedom information, encoding the screen data in the adjusted first window, and sending the encoded screen data to the head-mounted display apparatus for decoding and displaying comprises:
adjusting the first window according to the degrees-of-freedom information, compressing an edge region of the screen data in the adjusted first window and sending the compressed edge region to the head-mounted display apparatus for decoding and displaying.

4. The interaction control method according to claim 2, wherein the adjusting the first window according to the degrees-of-freedom information, encoding the screen data in the adjusted first window, and sending the encoded screen data to the head-mounted display apparatus for decoding and displaying comprises:
adjusting the first window and a second window according to the degrees-of-freedom information; and
combining and encoding the screen data in the adjusted first window and screen data in the adjusted second window, and sending the combined and encoded screen data to the head-mounted display apparatus for decoding and displaying,
wherein a second virtual screen runs a second application, and the second window renders screen data of the second virtual screen.

5. The interaction control method according to claim 4, further comprising:
acquiring posture information of a terminal apparatus; and
controlling the virtual identifier to rotate according to the posture information, so that there is a collision point between the virtual identifier and a target application in the application list or between the virtual identifier and the first window,
wherein the target application is the first application or the second application.

6. An interaction control device, comprising:
a receiving module configured to receive a touch operation of a user;
a creating module configured to, if there is a collision point between a virtual identifier and a first application in an application list, create a first virtual screen and a first window in response to the touch operation, run the first application on the first virtual screen, and render screen data of the first virtual screen to the first window;
an acquiring module configured to acquire degrees-of-freedom information of a head-mounted display apparatus; and
a sending module configured to adjust the first window according to the degrees-of-freedom information, encode the screen data in the adjusted first window, and send the encoded screen data to the head-mounted display apparatus for decoding and displaying.

7. The interaction control device according to claim 6, further comprising a determining module,
wherein the acquiring module is further configured to acquire position information of a collision point between the virtual identifier and the first window if a touch event is received,
wherein the determining module is configured to determine relative position information of the collision point in the first virtual screen according to the position information of the collision point, and
wherein the sending module is configured to distribute the touch event to the first virtual screen for responding, according to the relative position information.

8. The interaction control device according to claim 6, wherein the sending module is configured to:
adjust the first window according to the degrees-of-freedom information, compress an edge region of the screen data in the adjusted first window, and send the compressed edge region to the head-mounted display apparatus for decoding and displaying.

9. The interaction control device according to claim 7, wherein the sending module is configured to:
adjust the first window and a second window according to the degrees-of-freedom information; and
combine and encode the screen data in the adjusted first window and screen data in the adjusted second window, and send the combined and encoded screen data to the head-mounted display apparatus for decoding and displaying,
wherein a second virtual screen runs a second application, and the second window renders screen data of the second virtual screen.

10. The interaction control device according to claim 9, further comprising a control module,
the acquiring module is further configured to acquire posture information of a terminal apparatus;
wherein the control module is configured to control the virtual identifier to rotate according to the posture information, so that there is a collision point between the virtual identifier and a target application in the application list or between the virtual identifier and the first window, and
wherein the target application is the first application or the second application.

11. An electronic apparatus comprising:
a memory configured to store executable computer instructions; and
a processor configured to implement the interaction control method of claim 1 according to a control of the executable computer instructions.

12. A computer-readable storage medium having computer instructions stored thereon, wherein the interaction control method of claim 1 is performed when the computer instructions are executed by a processor.
